(19) United States
(12) Patent Application Publication
(10) Pub. No.: US 2025/0374024 A1
(43) Pub. Date: Dec. 4, 2025

(54) CONFIGURATION OF RECONFIGURABLE INTELLIGENT SURFACES (RIS) IN WIRELESS SYSTEMS

(71) Applicant: InterDigital Patent Holdings, Inc., Wilmington, DE (US)

(72) Inventors: Visa Tapio, Oulu (FI); Arman Shojaeifard, London (GB); Deepa Gurmukhdas Jagyasi, London (GB); Pekka Pirinen, Oulu (FI); Markku Juntti, Oulu (FI); Afshin Haghighat, Ile-Bizard (CA)

(73) Assignee: InterDigital Patent Holdings, Inc., Wilmington, DE (US)

(21) Appl. No.: 18/874,996

(22) PCT Filed: Jul. 11, 2023
(86) PCT No.: PCT/US23/27322

§ 371 Date: Dec. 13, 2024

Related U.S. Application Data
(60) Provisional application No. 63/359,983, filed on Jul. 11, 2022.
(60) Provisional application No. 63/468,954, filed on May 25, 2023.

(51) Int. Cl. H04W 8/00; H04B 7/04; H04W 24/10; H04W 72/21; H04W 72/231

(52) U.S. Cl. CPC H04W 8/005; H04B 7/04013; H04W 24/10; H04W 72/21; H04W 72/231

(57) ABSTRACT

A wireless transmit/receive unit (WTRU) may be configured to receive reconfigurable intelligent surface (RIS) discovery information. The RIS discovery information may indicate the presence of a RIS. The WTRU may perform one or more first measurements of one or more first signals to determine a first measurement value. The WTRU may determine that the first measurement value is less than a threshold. The WTRU may send a reservation request to the RIS based on the first measurement value being less than the threshold. The WTRU may perform one or more second measurements of one or more second signals received via the RIS to determine a second measurement value. The WTRU may determine that the second measurement value is less than the threshold. The WTRU may send a RIS configuration update request to the RIS based on the second measurement value being less than the threshold.

### CROSS REFERENCE TO RELATED APPLICATIONS

This patent application claims the benefit of U.S. Provisional Application No. 63/359,983 filed Jul. 11, 2022 and U.S. Provisional Application No. 63/468,954 filed May 25, 2023, the entire contents of which are each incorporated herein by reference in their entireties.

### BACKGROUND

The present invention relates to the field of computing and communications and, more particularly, to methods, apparatus, systems, architectures and interfaces for computing and communications in an advanced or next generation wireless communication system, including communications carried out using a new radio and/or new radio (NR) access technology and communication systems. Such NR access and technology, which may also be referred to as 5G and/or 6G, etc., and/or other similar wireless communication systems and technology may include features and/or technologies for a reconfigurable intelligent surface (RIS). As described herein, a RIS may be capable of adapting to radio environment conditions. For example, a RIS may be capable of electronically controlling the propagation of radio frequency (RF) signals impinging on a surface of the RIS. NR downlink (DL) beam management (BM) aims at adjusting the transmission and reception point (TRP) transmission (TX) beams and wireless transmit receive unit (WTRU) received (RX) beams.

A RIS may include a programmable structure (e.g., a RIS controller) that is used for controlling the propagation of electromagnetic (EM) waves, e.g., by changing the electric and magnetic properties of the surfaces of the RIS. By placing one or more RISs into an environment where wireless systems are operating, the properties of the radio channels used to communicate in the environment may be controlled. The control of radio channels may alter wireless system design, in which radio channel are seen as an uncontrollable entity that may distort the transmitted signals. In certain implementations, a RIS may be placed (e.g., on a wall) such that signals coming from a first (e.g., pre-determined) direction (e.g., from a base station or other network node) are directed towards the environment. The surfaces (e.g., walls, furniture, clothes, etc.) in such an environment may, for example, include a meta-surface based RIS. In certain implementations, the introduction of a RIS in a wireless communication system may provide coverage enhancement of wireless links. For example, the RIS may be used to enhance the signal-to-noise ratio (SNR) at the receiver. For example, radiation pattern of the RIS may be controlled such that the SNR may be improved at the receiver.

In order to properly control a RIS to enhance network coverage, certain techniques to measure channel quality may be implemented. In certain wireless systems, for example, one or more frequency and/or time resources may be reserved for channel quality measurements. In certain implementation, (e.g., as described in the 5G NR standard) channel state information reference signals (CSI-RS) and sounding reference signals (SRS) for downlink and uplink channel sounding may respectively be defined. These time and/or frequency resources may be utilized to perform RIS control.

The signaling for initial cell access (e.g., in the form of a synchronization signal (SS) block) may also be defined. For example, when a RIS is deployed in a wireless network (e.g., a 5G NR network), the SS block may be used to convey information about the presence and/or properties associated with a RIS to wireless transmit receive units (WTRUs). Further, beam establishment may be performed during a random-access procedure (e.g., a 5G NR random-access procedure). These resources may be adopted to be used to perform RIS control. As described herein, a RIS may be used to enhance the performance of any wireless system.

### SUMMARY

A wireless transmit/receive unit (WTRU) may comprise a processor configured to receive reconfigurable intelligent surface (RIS) discovery information. For example, the RIS discovery information may include an indication of the presence of a RIS (e.g., in a cell). The WTRU may receive one or more first signals and perform one or more first measurements on the one or more received first signals. The WTR may determine a first measurement value based on the first measurements. The WTRU may compare the first measurement value to a threshold and may, for example, determine that the first measurement value is less than the threshold. The WTRU may send a reservation request to the RIS based on the first measurement value being less than the threshold. The WTRU may receive one or more second signals and may perform one or more second measurements on the one or more second signals received. For example, the one or more second signals may be received via the RIS. The WTRU may determine a second measurement value based on the one or more second measurements. The WTRU may determine that the second measurement value is less than the threshold. The WTRU may send a RIS configuration update request (e.g., to the RIS) based on the second measurement value being less than the threshold. The WTRU may send the RIS reservation request and/or the RIS configuration update request as a first type of uplink control information (UCI).

The WTRU may further receive (e.g., via a RIS) one or more third signals and perform one or more third measurements on the received one or more third signals received to determine a third measurement value. The WTRU may determine that the third measurement value is greater than the threshold. The WTRU may perform data transmission via the RIS after determining that the third measurement value is greater than the threshold.

As described herein. a WTRU may receive RIS discovery information. The RIS discovery information may be received from a base station. Also, or alternatively, the RIS discovery information may be received (e.g., reflected) via a RIS. For example, the RIS discovery information may be received in a physical broadcast channel (PBCH) transmission.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example system that includes a reconfigurable intelligent surface (RIS);

FIG. 3 illustrates an example associated with the configuration of a RIS;

FIGS. 4A and 4B illustrate examples associated with a signal-to-noise ratio (SNR) that may be achieved in a system that includes a RIS;

FIGS. 5A and 5B illustrate other examples associated with an that may be achieved in a system that includes a RIS;

FIG. 6 illustrates an example associated with the control signaling that may be used for a system that includes a RIS; and

FIG. 7 illustrates an example protocol stack associated with a system that includes a RIS.

### DETAILED DESCRIPTION

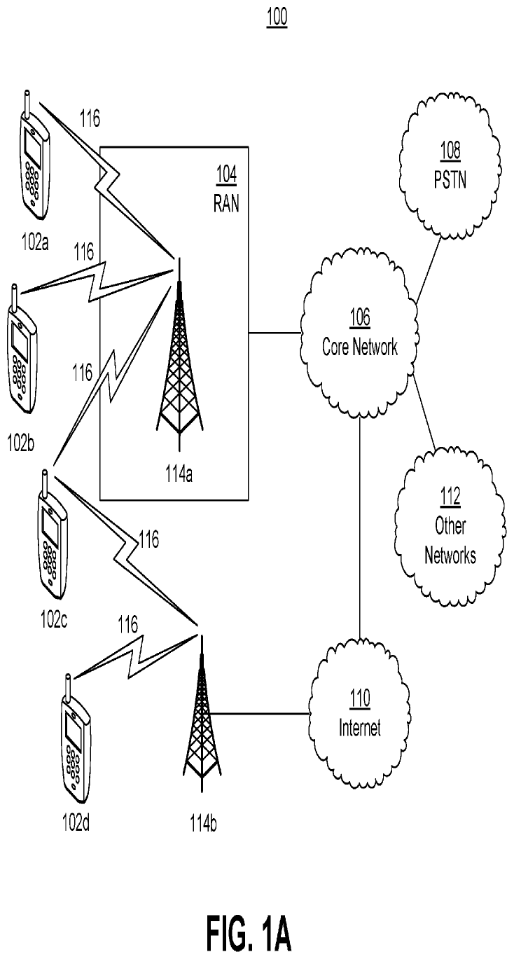

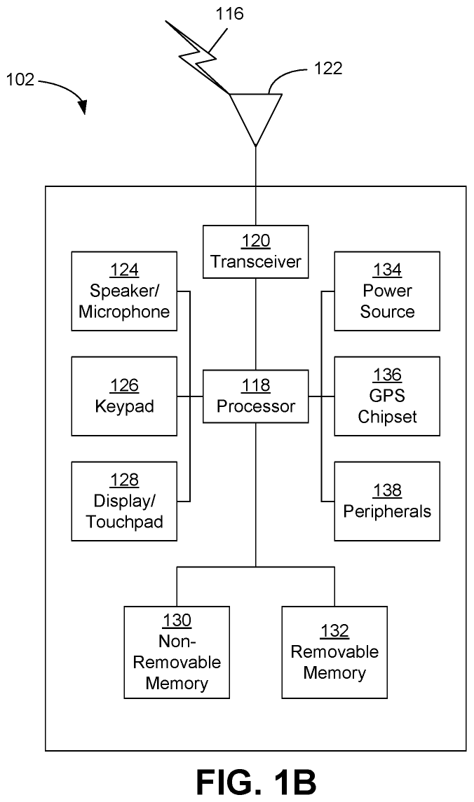

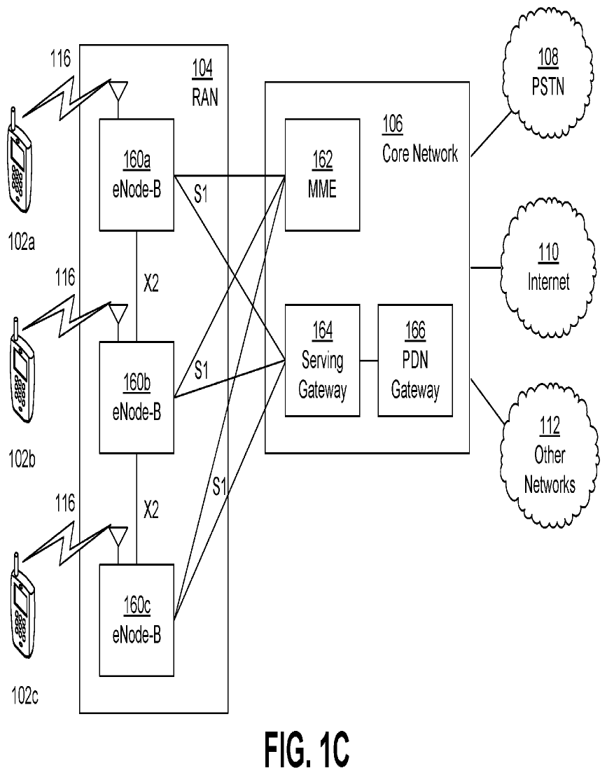

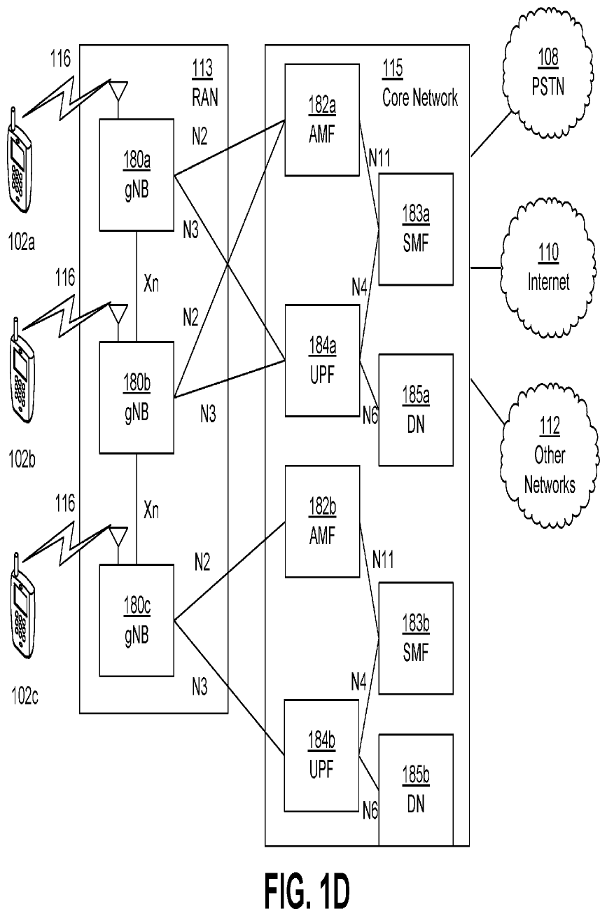

FIG. 1A is a diagram illustrating an example communications system 100 in which one or more disclosed embodiments may be implemented. The communications system 100 may be a multiple access system that provides content, such as voice, data, video, messaging, broadcast. etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), spatial domain multiple access (SDMA) and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112. though it will be appreciated that the disclosed embodiments contemplate any number of WTRUs. base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device. a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments. the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In certain implementations, the link quality in a wireless system may be degraded to support a selected application/service (e.g., due to shadowing, blocking, etc.). A RIS may be used to route electromagnetic waves around an obstacle, which may be causing the shadowing/blocking. In order to route signals around obstacles, the RIS may be configured to reflect or refract signal in the appropriate direction. However, RIS configuration may require channel estimation and optimization techniques, which may be computationally complex.

One or more techniques associated with RIS configuration are provided herein. As described herein, RIS confirmation may be based on one or more quality metric measurements (e.g., a signal-to-noise ratio (SNR), reference signal received power (RSRP), channel quality indicator (CQI), ACK-NACK, etc.). For example, instead of performing channel estimation and spectral and/or energy efficiency optimization techniques (e.g., which may be computationally complex), a RIS may be configured to achieve (e.g., attain, maintain, etc.) a predetermined quality level, which may be measured using quality metric measurements, such as SNR.

This application discloses methods to facilitate RIS-aided communications, for example, through downlink control information (DCI) and/or one or more transmission configuration indicators (TCIs) (e.g., two sets of DCI and two sets of TCI) for gNB-WTRU and RIS-WTRU links.

One or more techniques to achieve a target quality level (e.g., SNR) with a RIS may be provided. For example, one or more techniques (e.g., computationally simple techniques) to enhance/enable the coverage of a wireless system with a RIS may be provided. One or more of the following may apply.

The use of a RIS to improve, or enable, communication between a WTRU and gNB (e.g., or mobile terminals and base stations, access points and/or the like) may be executed using signaling between the network, a WTRU(s), and one or more RIS units. The configuration of a RIS may include the exchange of information and the transmission of control signaling between the WTRU(s), RIS unit, and/or the network.

RIS configuration (e.g., as a technique to optimize spectral or energy efficiency) may include the performance of channels estimation of the channel between the transmitter and the RIS and the channel between the RIS and the receiver. The channel estimation that is performed for RIS configuration may be computationally intense. For example, channel estimation may include the transmission of training sequences, and the receiver may receive and store the received samples during the training (e.g., before the optimization problem can be solved). Furthermore, to increase (e.g., maximize) the possible gain from using a RIS in a wireless system, the RIS may form a narrow beam pattern, e.g., to pick up the signal coming from the transmitting node and to reflect or refract the signal towards the receiving node. The RIS may also, or alternatively, form a narrow beam pattern to enhance the coverage of wireless links. In order to form a narrow beam, the RIS may perform a search process, which may increase (e.g., cause excessive) overhead on the RIS assisted link. The overhead associated with RIS configuration may affect (e.g., compromise) the potential gain offered by a RIS. In certain implementations, channel estimation and the associated search process for the RIS configuration may be simplified, for example, by using a majority voting algorithm (e.g., to maximize the received SNR).

The techniques described herein may be used to simplify and accelerate the RIS configuration process. For example, the techniques described herein may include attaining and/or maintaining a predetermined channel quality (e.g., measured with an SNR and/or any other suitable performance indicator). Certain other implementations, however, do not consider the initial access scenarios described herein. Certain other implementations also do not consider that RIS configuration may be based on measurements performed at a WTRU, as described herein.

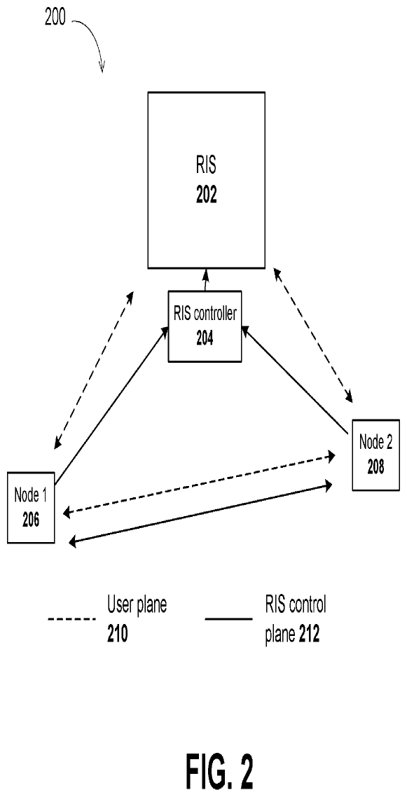

A system model associated with a wireless system that includes a RIS 204 may be provided. One or more of the following may apply. For example, FIG. 2 illustrates an example system 200 that includes a RIS 202. As shown in FIG. 2, the system 202 may include: one or more (e.g., two, three, four) single antenna nodes, a RIS 202, and an associated RIS controller. The RIS 202 may be a standalone unit, part of the network, and/or controlled (e.g., fully controlled) by a WTRU. The RIS 202 may be connected to the RIS controller, which may be configured to communicate with the receiving node. The RIS controller may also be part of the RIS 202. For example, the receiving node may be configured to provide feedback, via the RIS controller, for configuration of the RIS 202. The RIS controller may be located at the RIS 202 site. As shown in FIG. 2, the nodes may communicate with the RIS controller, e.g., even if a link (e.g., the direct link) between the nodes is blocked (e.g., is completely blocked). In certain scenarios, the RIS controller may not be co-located with the RIS 202. For example, the RIS controller may be deployed at any location as long as the measurement results (e.g., received signal power, SNR, etc.) or performance indicators calculated based on the measurement results, can be communicated from the receiving node to/from the RIS controller and the RIS controller can configure the RIS 202 hardware. As described herein, a single RIS controller may control more than one RIS. Alternatively, one or more RIS controllers may control a single RIS. If, for example, the RIS controller and the RIS 202 are not co-located, an additional connection between RIS 202 and the RIS controller may be employed. Control plane messages may be transmitted/received between the RIS 202 and the nodes. The RIS controller may be equipped with a low power. low complexity transceiver. The control plane messages transmitted/received between the RIS 202 and the nodes (e.g., RIS control plane messages) may be different from the messages communicated over the control planes of existing wireless systems, and the RIS control plane 212 may be implemented independent of and/or integrated into the served wireless systems. The RIS control plane may comprise a Radio Resource Control layer (RRC) that is responsible for configuring the lower layers. As shown in FIG. 2, if a link (e.g., a direct link) exists between Node 1 206 and Node 2 208, the nodes may also share control information directly with each other. User plane 210 may carry the data being transmitted throughout system 200. User plane 210 may comprise one or more of the following sub-layers: PDCP (Packet Data Convergence Protocol), RLC (radio Link Control), and Medium Access Control (MAC).

A RIS 202 may be configured based on a channel quality indicator (e.g., received SNR). Although techniques are described herein using SNR as an example channel quality indicator, other similar channel quality indicators may also, or alternatively, be used. One or more of the following may apply. The SNR threshold (e.g., requirement) may be defined at the receiving node (RX node). For example, the SNR threshold may be defined based on the requirement of a used application or service (e.g., the SNR threshold is defined from the upper layers to the physical layer). The SNR threshold may also, or alternatively, be defined based on previous SNR values measured by the RX node. For example, if the RX node detects a drop in the measured SNR value, the RX node may initiate a RIS configuration process. The RIS configuration process may be initiated at the physical layer. The RIS configuration techniques described herein may be applied regardless of the source for the SNR threshold. When the SNR threshold is not met at the link between Node 1 206 and Node 2 208, the RIS 202 may be reserved for the connection. In certain implementations, the RX node may communicate with the RIS controller to control (e.g., directly control) the RIS 202. The RIS controller may also, or alternatively, inform/notify the transmitting node (TX node) about the use of the RIS.

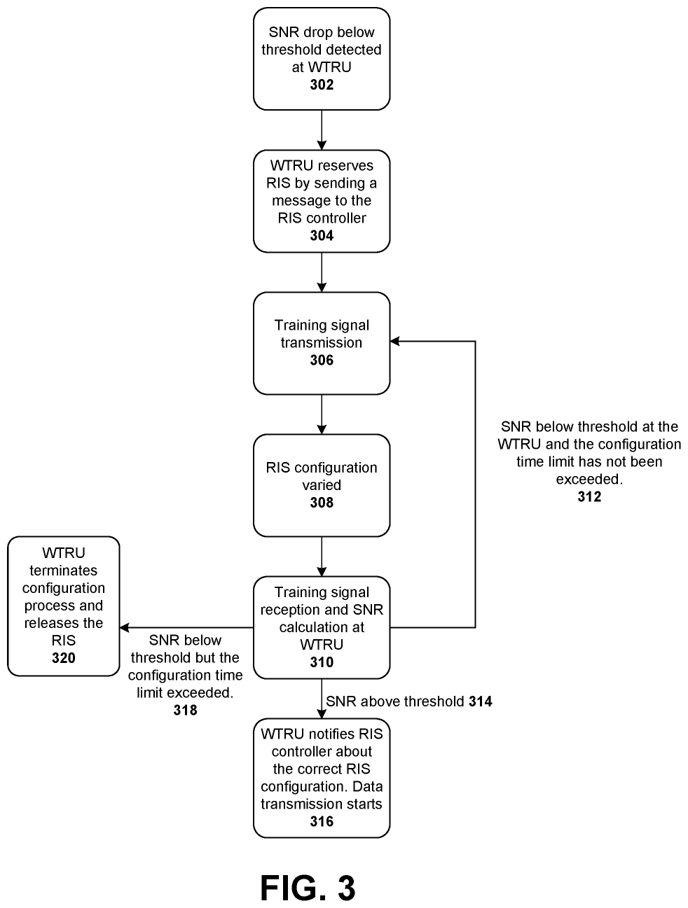

FIG. 3 illustrates an example associated with a RIS configuration procedure. One or more of the following may apply. The measured SNR may be less than an SNR threshold. For example, the SNR threshold may be defined based on a link quality requirement, e.g., data rate. The RX node may measure the SNR of an input signal. For example, the SNR may be measured with a signal that is designed for channel and noise estimation purposes (e.g., also referred to as reference or training signals, such as channel state information reference signal (CSI-RS), sounding reference signal (SRS), etc.) Reference signals may be multiplexed with user and other data symbols. Also, or alternatively, reference signals may be transmitted as a part of a preamble.

As shown in FIG. 3, at step 302, a WTRU may detect that a signal to noise ratio (SNR) drops below a threshold. At step 304, the WTRU may reserve the RIS, for example, by sending a message to the RIS controller 204 or the RIS 202. One or more of the following may apply. When the measured SNR is below the SNR threshold, the Rx node may send a request to the RIS controller 204 to reserve the RIS. If the RIS is not used by any other node pair the request sent by the RX node to use the RIS may be granted. The RIS controller 204 may inform the TX node (e.g., gNB) about the use of the RIS. At step 306, the RIS controller 204 may instruct the TX node to transmit the training, and/or reference signal, to be used for SNR measurement. For example, the RIS controller 204 may instruct the TX node transmit to the training, and/or reference signal with shortest periodicity allowed by the system 202.

At step 308, the configuration of the RIS may be varied. One or more of the following may apply. Configuration of the RIS may be varied to synchronize with the transmission of the training signal by the TX node. For example, configuration of the RIS may refer to the process by which the parameters associated RIS are configured to reflect and/or refract signals impinging on the RIS (e.g., like beamforming). The parameters may comprise one or more of the following: phase response, amplitude response, phase and amplitude response, unit-cells grouping (sub-surfaces), and/or on-off information. The parameters associated with the RIS may be varied (e.g., changed/updated) until a measured quality metric (e.g., SNR) associated with the training signal is greater than or equal to a threshold quality metric, as further described herein. Further details associated with the configuration of the RIS may depend on the RIS implementation.

At step 310, the training signal may be received (e.g., by the WTRU) and the SNR may be calculated. One or more of the following may apply. At step 312, if the RX node (e.g. WTRU) calculates that the SNR is below the threshold and the configuration time limit has not been exceeded, the RX node may continue to receive the training signal transmission, vary the RIS configuration, and measure the SNR of its input signal.

At step 314, the measured SNR may be greater than the SNR threshold. If the measured SNR is greater than the SNR threshold, at step 316, the RX node may notify/inform the RIS controller 204 that the measured SNR is greater than the SNR threshold. Configuration of the RIS may cease, and the data may be transmitted using the RIS based on the RIS configuration associated with the measured SNR being greater than the SNR threshold.

At step 318, the measured SNR may be less than the SNR threshold (e.g., less than the SNR threshold longer than a time limit, which may be defined by the system). The time limit may, for example, be set by the WTRU (e.g., for time-critical communications), the RIS controller, and/or the network (e.g., defined in radio link control or radio resource control layers). If none of the RIS configurations tested within a time limit (e.g., a time limit set by the system) results in the measured SNR being greater than the threshold SNR, at step 320, the RIS configuration process may stop and the RIS may be released. In certain scenarios, the time limit (e.g., for the timer) may be configured by the gNB for the WTRU, for example, as part of DCI. For example, the DCI received by the WTRU may include an indication of the time limit (e.g., in terms of a certain unit of time, such as X seconds, and/or unit of radio transmission, such as X slots). In examples, the WTRU may provide the gNB with historical information about the RIS training time taken versus configured time limits, such that the gNB may accordingly update the time limit as desired. There may be triggers, at the WTRU and/or signaled from the gNB, for providing such RIS training time information. For example, the triggers for a WTRU to send RIS training time information may comprise: triggers received from the network (e.g., gNB) through signaling (e.g., MAC CE/DCI, etc.), and/or triggers initiated by the WTRU through signaling (UCI, SRS, etc.) based on a configuration received from the gNB (e.g., RRC, MAC CE, DCI, etc.). The WTRU may provide this information as part of the RIS training or configuration procedure, e.g., as described herein with respect to FIG. 3. The triggers and/or the RIS training reporting structure may be configured by gNB.

The timing associated with the configuration of the RIS may be known by both nodes (e.g., Node 206 and Node 208 of FIG. 2). One or more of the following may apply. The RIS controller may coordinate the configuration process. For example, the RIS controller may inform both the TX and the RX node when the training signal(s) are to be transmitted and/or when the RX node is expected to receive the training signal. Also, or alternatively, the TX node may schedule the RIS configuration (e.g., based on the TX node's training signal transmission interval). If the TX node schedules RIS configuration, the RX node may wait to receive a known sequence and may perform the SNR estimation when (e.g., only when) the training signal is detected. When, for example, only noise is received, samples may not be stored. Also, or alternatively, noise samples may be used for noise estimation. In certain scenarios, the nodes may agree on the timing together, for example, using control plane signaling. For example, the node may directly communicate using the control plane to agree on the timing. Also, or alternatively, the nodes may communicate via the RIS controller to agree on the timing (e.g., if the direct link between the nodes is blocked).

As described herein, control signaling may be used during RIS configuration. One or more of the following may apply. When the RX node detects/determines that the measured SNR is less than the threshold SNR, the RX node may communicate with the RIS controller. An initial connection between the RX node and the RIS controller may be established when the RX node arrives at the network or a cell in the network. For example, the presence of the RIS in a cell may be advertised via an added data field in the control plane signaling transmitted by the network. An initial connection between the RX node and the RIS controller may also, or alternatively, be established when the RIS controller transmits a beacon signal to advertise its presence. An initial connection between the RX node and the RIS controller may be established when the RX node transmits a request signal, e.g., to seek an available RIS. The choice between the different options and implementation details depends on the network where the RIS is deployed. During configuration of the RIS, the RX node may measure the received SNR and report the measurement results (e.g., or performance indicators calculated based on the measurements) to the RIS controller. The signaling to indicate the measured SNR may not require a high link capacity, for example, since the information from the RX node includes (e.g., only includes) the measurement result or the performance indicator, which may be a single number. The latency requirement may be low, for example, depending on the implementation of the RIS assisted link and/or to minimize the time for configuration of the RIS.

The control signaling used for configuration of a RIS may be implementation specific and/or may vary for different deployments scenarios. The techniques described herein are examples, and any other suitable techniques may also, or alternatively, be used.

One or more techniques to provide extension to multi-antenna nodes may be provided. The WTRUs and the network nodes (e.g., base stations (BSs) or access points (AP)) in a wireless system may be equipped with antenna arrays that include one or more (e.g., multiple) antenna elements. The RIS configuration techniques described herein may also be used with TX and RX nodes that include multiple antenna elements. One or more of the following may apply.

If a TX node is equipped with an antenna array, orthogonal training sequences may be transmitted from each antenna. The individual training sequences may be transmitted in certain directions, for example, based on (e.g., based only on) the radiation patterns of the array elements. For example, the individual training sequences may be transmitted omnidirectionally if the array elements are dipole elements. In certain scenarios (e.g., in 5G NR), the SRSs transmitted from different antenna ports may be orthogonal to each other. If, for example, the RIS is located in the far-field of the TX node's array, the plane waves may arrive at the RIS from a similar (e.g., the same) direction (e.g., due to transmitted orthogonal sequences) and/or may be reflected in a similar (e.g., the same) direction. The RX node may detect the orthogonal sequences and measure the associated SNR of the received signal. If the RX node is equipped with an antenna array, the SNR may be calculated at each transmitter chain connected to an array element, which may result in diversity gain for the SNR measurement.

After the appropriate RIS configuration has been determined (e.g., using the techniques described herein with respect to FIG. 3), the RX node may estimate the channel. The WTRU may notify the RIS controller about the correct RIS configuration and data transmission may start. The RX node may report the channel state information (CSI) to the TX node. The TX node may perform precoding. The RX node may perform combining. The precoding performed at the TX node and the combining performed at the receiving node may be computed using already existing techniques (e.g., as in traditional multi-antenna systems). The associated codebook may be redesigned, for example, to utilize the performance improvement offered by a RIS. However, since precoding at the TX node may be performed after RIS configuration, the techniques described herein are agnostic to any associated codebook redesign.

In addition to an SNR, other quality indicators may also, or alternatively, be utilized in the RIS configuration. One or more of the following may apply. In wireless systems, a WTRU may use one or more (e.g., several) performance indicators to assess the link quality. In certain implementations (e.g., 5G NR), for example, the performance indicators may include the channel quality indicator (CQI), rank indicator (RI), pre-coder matrix indicator (PMI) and/or reference-signal received power (RSRP). CQI values may include a number between 0 and 15 and may be used to choose a modulation and coding scheme from tables defined in 5G NR specifications. The RI may indicate the number of transmission layers that a WTRU determines that the channel can support. The PMI indicates the precoder matrix suitable for a transmission (e.g., when the RI is known). The RSRP used for layer 1 reporting may be suitable for beam management and/or may be referred to as L1-RSRP. In certain implementation (e.g., IEEE 802.11 networks), the parameters for the link quality assessment may include the received signal strength indicator (RSSI), signal-to-interference-plus-noise ratio (SINR), carrier to noise ratio ((CNR) e.g. a measure of the received carrier strength relative to the strength of the received noise), packet delivery ratio (PDR), and/or bit-error-rate (BER). For example, the techniques described herein may be supported by one or more of the following: L1-RSRP, SINR and/or RSSI. The RI indicator may be utilized during RIS configuration, for example, if the SNR is determined to be suitable for the transmission and the rank of the channel does not support multi-layer transmission. In such an example, configuration of the RIS configuration may increase the channel capacity. The CQI and/or PMI may also, or alternatively, be utilized in RIS configuration.

Certain other wireless systems may use different channel quality indicators, and the implementation of each of the different channel quality indicators may vary, for example, depending on the specific requirements and resources. Nevertheless, the techniques described herein associated with RIS configurations may be employed irrespective of the channel quality indicator that is used.

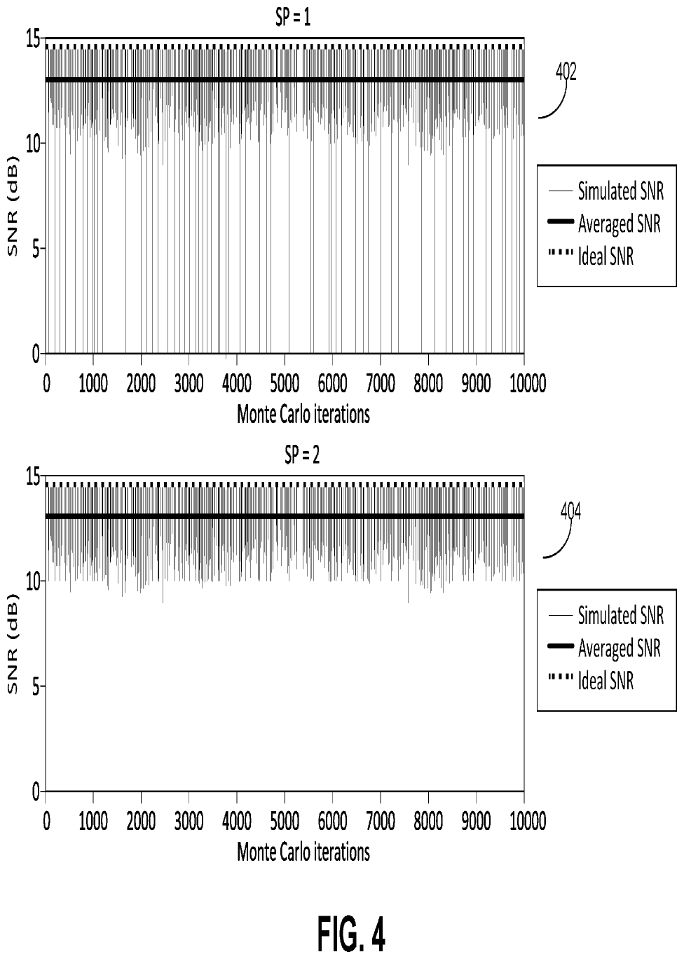

FIG. 4 illustrates examples associated with simulations (e.g. for the outdoor use case) associated with the techniques described herein. Referring to the examples illustrated in FIG. 4, one or more of the following may apply. The distances (e.g. the horizontal distances) between the WTRU and the RIS and between the RIS and the BS may be 5 m and 180 m, respectively. The WTRU antenna, BS antenna and RIS heights may be 1.5 m, 5 m and 10 m, respectively. The transmit power may be 20 dBm, the signal bandwidth may be assumed to be 20 MHz, and the noise figure of the receiver may be 5 dB. Path losses have been calculated using the urban micro-street canyon model defined. Both the WTRU and BS may be equipped with a single antenna. The RIS may be modelled as a 64-element uniform linear array that includes a λ/2 element spacing (e.g., where λ=wavelength of the signal). The antenna and RIS elements may be assumed to be isotropic radiators. The codebook in the search may include one or more rows of a discrete Fourier transform (DFT) matrix. Referring to the SP=1 402 case illustrated in FIG. 4, the codebook size may be 64. Referring to the SP=2 404 case illustrated in FIG. 4, the codebook size may be 128. The target SNR value in both cases may be 10 dB. In the SP=1 402 case the fail rate may be 0.01, while in the SP=2 404 case the fail rate may be reduced to 0. The average number of iterations in the search may include 33 and 63 in the SP=1 402 and SP=2 404 cases, respectively.

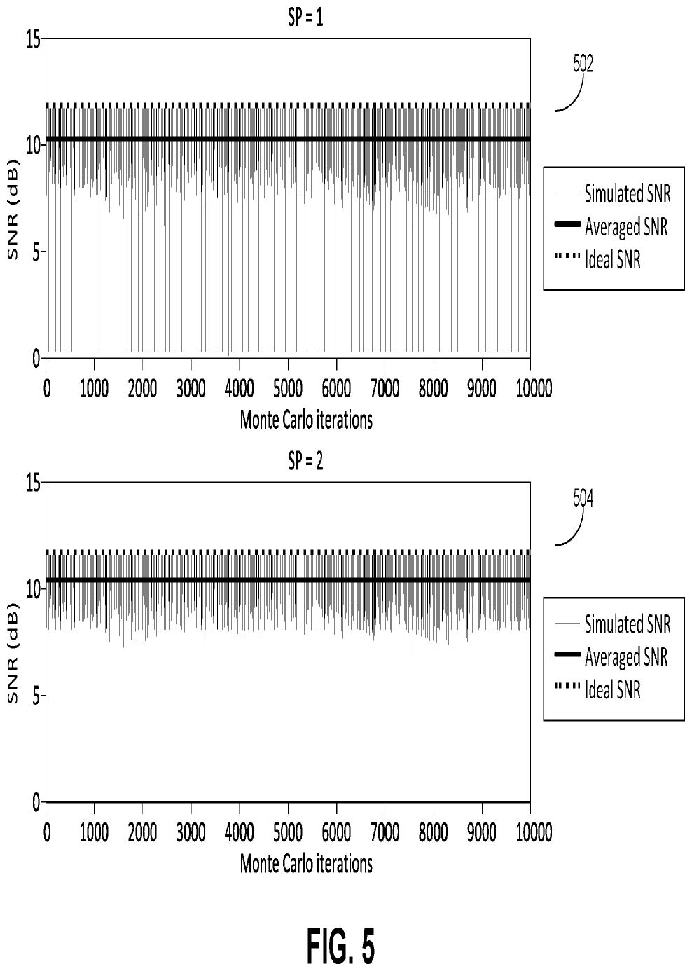

FIG. 5 illustrates examples associated with simulations (e.g., for the indoor use case) associated with the techniques described herein. One or more of the following may apply. The distances between the WTRU and the RIS and between the RIS and the BS may include 7.5 m and 15 m, respectively. The WTRU antenna, the BS antenna, and the RIS heights may be 1.5 m, 2.5 m and 2 m, respectively. The path losses may be calculated using an indoor-office model. The RIS size may be 64 and both the WTRU and BS may be single antenna devices. Referring to the SP=1 502 case illustrated in FIG. 5, the fail rate may be 0.03. The fail rate in the SP=2 case may be 0. The average number of iterations performed during the search for SP=1 502 and SP=2 504 case may be 33 and 63, respectively.

As shown in FIGS. 4 and 5, the fail rate and/or search time may depend on the size of the codebook. For example, an increase in the codebook size may be associated with a reduction in the fail rate and an increase in the search time. The techniques described herein, however, may be used with various (e.g., any) codebook design. Further, the DTF matrix described in connection with the examples illustrated in FIGS. 4 and 5 are exemplary and was used to illustrate the operation and performance of the RIS configuration.

The RIS configuration techniques described herein may be applied to various networks, including, but not limited to, 5G NR. For example, a RIS discovery procedure may be performed, for example, as part of an initial access procedure. One or more of the following may apply. A network node, such as a base station (e.g., gNB), may periodically transmit synchronization signal (SS) blocks. The periodicity of the transmitted SS blocks may vary, for example, between 10 ms and 160 ms. For example, the SS block may include a primary synchronization signal (PSS), a secondary synchronization signal (SSS), a broadcast signal, and/or an indication of a physical broadcast channel (PBCH). In some cases, the broadcast signal may carry part of the system information used for the WTRU to access or synchronize with the network

A RIS controller may be equipped with transceiver (e.g., such as the transceiver 120 illustrated in FIG. 1B). For example, the RIS controller may use the transceiver to advertise certain information (e.g., via a beacon signal) associated with the RIS (e.g., available RIS resources). The gNB may configure the WTRU to assist the WTRU with the RIS discovery and discovery of available RIS resources, e.g., as part of the initial access procedure. For example, the WTRU may be configured to receive and/or decode information advertised by the RIS(s) in the cell. In certain scenarios, a RIS beacon signal sent by the RIS controller may be synchronized with other control signal transmissions from a gNB. WTRUs located within the coverage area of RIS may receive this information advertised by the RIS. For example, the RIS controller may include one or more of the following in its advertisement: the presence of the RIS unit (e.g., or if more than 1 unit is controlled by the same controller, the number of RIS units); properties of RIS units (e.g., dimensions, number of elements, array gain, etc.); information associated with the RIS type and/or RIS capabilities (e.g., active/passive, reflective/transmissive, etc.); location of the RIS units; information type expected from WTRUs (e.g., RIS configuration and/or preferred phase shift matrix); one or more performance indicators (e.g., SNR, CQI, RI, PMI, RSRP); information that may be used for RIS element configuration; and/or a link quality indicator (e.g., for the RIS controller to calculate the RIS configuration depending on the RIS implementation).

Based on the information advertised by the RIS controller, a WTRU may determine to use one or more RIS resources, e.g., by initiating a RIS configuration procedure. If, for example, a WTRU wants to use a RIS resource, the WTRU may send a RIS resource request to the RIS controller. Also, or alternatively, the WTRU may send a RIS resource request to a network node (e.g., gNB), which may then forward the RIS resource request to the RIS (e.g., the RIS controller). During the RIS configuration, the WTRU may communicate with the RIS controller.

The WTRU may define the RIS configuration based on a signal quality indicator, e.g., in CSI. The information included in the RIS controller transmissions (e.g., the information advertised by the RIS controller) may indicate the structure and properties of RIS units. For example, the structure and properties of a RIS unit may include a number of RIS elements, phase and amplitude ranges of RIS elements, and/or a mode of operation (e.g., reflection, refractions, absorption, etc.). This information may be included in RIS controller transmissions and/or may further include detailed information about the unit cells of the RIS (e.g., the number of unit cells); which components are used to control the operation of unit cells (e.g., PIN-diodes, transistors); the number of bits in control words used to control a single unit cell in the RIS; and/or the phase and amplitude responses of the unit cells induced by the control words. Also, or alternatively, that the WTRU may send the CSI to the RIS controller, and the RIS controller may define the details for the RIS configuration. In this case, the WTRU may not know the details of the manufacturing and component technology used to implement RIS units.

As described herein, the beacon and the control signaling between the WTRU and RIS controller may also, or alternatively, be implemented using narrow-band internet-of-things (NB-IoT) transmissions (e.g., using 5G in-band transmissions or guard-bands between 5G carriers). Also, or alternatively, a distinct radio link for the WTRU to RIS control signaling may be defined. The gNB and/or WTRU may configure one or more new dedicated control links for the RIS. The new dedicated control links may be lower in complexity than e.g., PDCCH/PUCCH (physical downlink/uplink control channel) used for WTRU-gNB communications. The one or more new dedicated control links may be called Physical RIS Control Channels (PRCCs). The distinct radio link may be realized with other radio technology than the one used for data transmission between the WTRU and gNB. As an example, the RIS may be used for a link between the WTRU and gNB, but the control signaling between the WTRU and RIS controller may be done with one or more wireless local area network transmissions.

In certain scenarios, RIS discovery may be performed without transmissions from the RIS controller. For example, a network node (e.g., gNB) may transmit (e.g., periodically transmit) SS blocks. The periodicity of the SS blocks may vary, for example, between 10 ms and 160 ms. The SS block may include the primary synchronization signal (PSS), the secondary synchronization signal (SSS), and/or the PBCH. For example, the PBCH may include the master information block (MIB), which includes information for the WTRU to be able to acquire system information about the network (e.g., the scheduling information used to receive the system information block 1 (SIB1)).

During an initial access procedure, a WTRU may search for an available cell, and wait to receive the associated SS. After the WTRU detects the SS, the WTRU may synchronize with the network and acquire system information associated with the network. If a RIS is present in a cell, information that indicates the presence of the RIS may be added in the data transmitted in the PBCH. The WTRU may continue to monitor the SS block transmission. If the RIS has not been reserved for a link between the gNB and a WTRU, the network may vary the RIS configuration. For example, the network may synchronize configuration of the RIS with transmission of the SS block. Also, or alternatively, information associated with the periodicity of the RIS configuration may be included in the PBCH content.

If a RIS is present in the cell, the information indicating the presence of the RIS may be added in the data transmitted in the PBCH. For example, one or more information bits may be added to the MIB, which may be used to indicate the presence (e.g., or absence) of a RIS in the cell. In examples, the MIB may include one or more of the following fields: cellBarred, dmrs-TypeA-position, intraFreqReselection, pdcch-ConfingSIB1, ssb-SubcarrierOffset, subCarrierSpacingCommon, systemFrameNumber, and/or an indication of the presence of a RIS (e.g., a RIS-present field).

In examples, the RIS information (e.g., RIS-present field) may be included in the SIB1 transmitted (e.g., periodically transmitted) in the physical downlink shared channel (PDSCH). The WTRU may continue to monitor for the SS block transmission. If, for example, the RIS has not been reserved for any link between a network node and a WTRU, the network may vary the RIS configuration, e.g., to be synchronized with the SS block transmission. The network may vary the RIS configuration through explicit signaling, e.g., from the gNB to the RIS controller. For example, this signaling between the gNB and the RIS controller may be transmitted via a backhaul link, wired, in-band, out-of-band, and/or the like. The information about the periodicity of the RIS configuration may also be added to the PBCH (e.g., by extending the MIB or SIB1).

If a RIS discovery procedure is performed as a part of an initial access procedure, one or more of the following may apply. A RIS and/or RIS controller may be deployed. A RIS information field may be included in the PBCH, (MIB), and/or SIB1CH. For example, the RIS information field may indicate the presence of the RIS and/or the timing information associated with RIS configuration. A control link between the RIS controller and the WTRUs may be established.

Configuration of a RIS may, for example, be performed at the beginning of data transmission and/or during initial access.

A link (e.g., a direct link) may be established between the WTRU and the gNB exist or a direct link may not exist. In certain instances, however, the measured SNR associated with the link may be below a threshold SNR. One or more of the following may apply. The WTRU may initiate a data transmission. The WTRU may measure the power of the received SS block and calculate the associated SNR. If the SNR is below the threshold SNR, the WTRU may transmit a request to reserve the RIS to the RIS controller If the RIS is available, the WTRU may be granted control of the RIS.

In certain scenarios, the WTRU may continue to monitor the SNR measured from the SS block, for example, while the RIS configuration is updated. When the SNR reaches or exceeds the SNR threshold, the WTRU may reserve the RIS and inform the RIS controller to use the corresponding RIS configuration. The WTRU may initiate the data transmission with the gNB.

In certain scenarios, the link between the WTRU and the gNB may be established even when the measured SNR level is lower than SNR threshold. The WTRU may reserve the RIS. The gNB may transmit a CSI-RS, for example, with minimum periodicity (e.g., 5 ms). When the SNR reaches or exceeds the SNR threshold, the WTRU may instruct the RIS controller to use the corresponding RIS configuration, and data transmission may be initiated. If the threshold SNR is not achieved after a predetermined time, the RIS may be released.

As described herein, a WTRU may send configuration instructions to a RIS controller. In certain scenarios, the WTRU may send control instructions to the gNB, which in turn may relay them to the RIS controller. Also, or alternatively, the WTRU may communicate directly with the RIS controller.

If the WTRU sends control instruction the gNB, the RIS control information may be sent to the gNB may be included in uplink control information (UCI) comprised in a physical uplink control channel (PUCCH) transmission. The UCI may also, or alternatively, be sent in a physical uplink shared channel (PUSCH) transmission. Depending on the RIS implementation and/or how RIS units are integrated to the network, a control messaging arrangement may be used to transmit RIS control information (RCI). If the RIS is deployed by the network operator, the connection between the RIS controller and gNB may, for example, comprise extending a given interface (e.g., the F1 interface used for interconnecting base stations-centralized unit (gNB-CU) and base station-distributed unit (gNB-DU) to include the interface between the gNB and RIS controller).

If the WTRU communicated directly with the RIS controller, the RIS controller may include a transceiver. For example, the WTRU may communicate with the RIS controller to perform RIS configuration if the link between the gNB and the WTRU is blocked.

As described herein, UCI may be used to send channel state information (CSI), hybrid automatic repeat request (HARQ) acknowledgements, and scheduling requests to the network. UCI may also be used to report CSI from the WTRU to gNB for RIS control and/or RIS configuration if the connection between the gNB and a WTRU has been established. If, however, a direct link between the WTRU and gNB is blocked, the WTRU may communicate with the RIS controller (e.g., to receive transmissions from the network before the WTRU starts transmitting to the network). The RIS configuration (e.g., the selected RIS configuration and/or preferred RIS configuration) may be determined before user plane data transmissions between the WTRU and gNB take place. For example, the RIS configuration may be determined by measuring the power of synchronization signals transmitted by a gNB and reflected by the RIS to the WTRU. Based on the measured power of the synchronization signals (e.g., the WTRU-gNB and WTRU-RIS channels), the WTRU may be determine the RIS configuration and transmit an indication of the determined RIS configuration to the RIS controller. The WTRU may report the received signal quality (e.g., received power and/or SNR) or instructions for the RIS configuration to the RIS controller, for example, using a radio link between the WTRU and RIS controller (e.g., UCI for the RIS controller-WTRU link). In examples, the WTRU may not send the determined RIS configuration to the RIS controller. For example, the WTRU may transmit an indication and/or information for the RIS controller to update its configuration (e.g., since performance has dropped below a certain threshold). The information may also include some measurement information, which may be used by the RIS controller select the appropriate RIS configuration.

The size and/or associated technologies of a RIS may vary. The WTRU may control the RIS, e.g., by defining RIS configurations at the circuit level (e.g., directly controlling reflections of single RIS elements) if the WTRU receives information about the RIS units deployed in the cell. For example, the information about the RIS units deployed in the cell may include, but is not limited to, a predetermined set of beams of the RIS (e.g., in which case the WTRU may transmit an index to indicate the selected a beam) The information sent by the RIS controller may also include detailed information on how individual RIS elements operate, which the WTRU may use to determine a desired phase responses or phase and amplitude responses of the RIS elements. The detailed information may comprise information such as range of the phase and amplitude that the RIS elements can support (e.g., for phase, there may be a set of discrete values to select from as opposed to a continuous phase capability). The RIS controller may send one or more of the following to the WTRU: preferred set of beam IDs/index from a predefined set; a desired phase response (e.g., based on WTRU processing of received beams); and/or a desired phase and amplitude response (e.g., based on WTRU processing of received beams).

The RIS controller may provide this information to the WTRU if the radio link between the RIS controller and the WTRU exists. Also, or alternatively, the WTRU may report the CSI to the RIS controller and the RIS controller may determine the RIS configuration (e.g., based on the CSI). For example, the WTRU may report the CSI to the RIS controller if details associated with the RIS implementations may not be visible to the WTRU or the network.

As described herein, DCI may be used for scheduling (e.g., including sidelink scheduling) and sending transmit power control (TPC) messages to the WTRU. When the RIS controller communicates with a WTRU over a radio link (e.g., in the WTRU controlled case), the RIS controller may send information about the RIS properties and acknowledgements for the request for RIS resources to the WTRU (e.g., DCI in the RIS controller-WTRU radio link). In addition to a first DCI between gNB-WTRU, the gNB and/or the WTRU may configure a second DCI between RIS controller-WTRU to enable exchange of control information.

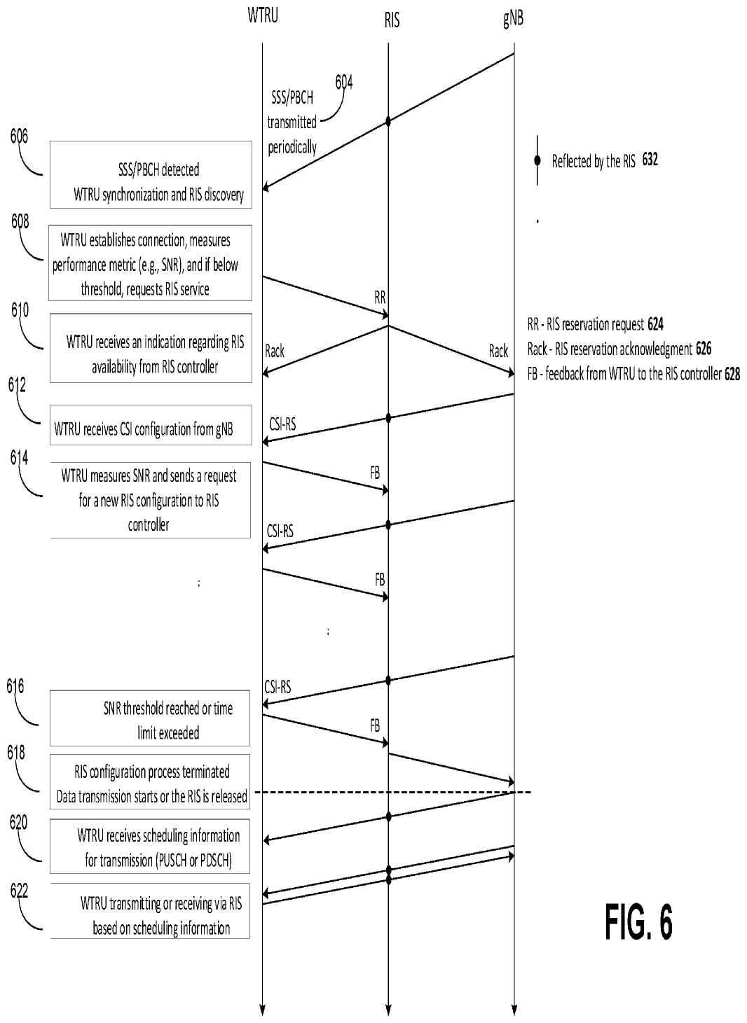

FIG. 6 illustrates an example associated with RIS configuration signal timing. As illustrated in FIG. 6, the RIS configuration may be varied, e.g., to be synchronized with transmission of the SS block. When a WTRU receives the SS block, the WTRU may synchronize with the network and receive system information from the PBCH. The PBCH may include the information about the periodicity of the RIS configuration. After PBCH reception, the WTRU may determine the network and RIS controller timing. If the WTRU seeks to establish a connection for the data transmission, the WTRU may reserve the RIS, for example, by transmitting a RIS reservation request (RR). The WTRU may inform the RIS controller that it was able to receive signals from the gNB with the corresponding RIS configuration. The RIS controller may transmit a RIS reservation acknowledgement (Rack), e.g., to verify that the RIS is reserved for the WTRU. The RIS configuration may be initially set to the configuration received from the WTRU. The RIS reservation request may be sent (e.g., explicitly sent) as part of one or more uplink physical channels or signals (e.g., physical random access channel (PRACH), PUCCH, PUSCH, SRS) or implicitly through certain selection of UL resources (e.g., PRACH, PUCCH, PUSCH, SRS). If the SNR threshold specification is not met, the set RIS configuration may be used as the starting point for the RIS configuration (e.g., as illustrated in FIG. 3). The WTRU may receive the SNR threshold via pre-configuration by the gNB (e.g., RRC) or dynamic configuration by the gNB (e.g., MAC CE, DCI, etc.). The WTRU may determine and indicate a second threshold (e.g., dynamically) based on its own measurements. During RIS configuration, the WTRU may send feedback (FB) signal to the RIS controller. A FB signal may include performance indicators for the RIS controller. The RIS controller may use the FB signal to determine the next configuration or direct instructions for the RIS configuration. If the WTRU has not moved far from the position where it was able to receive the SS block. the FB signal be used to optimize RIS configuration. When the threshold SNR value is reached, the RIS configuration may conclude, and data transmission may start. If the SNR target is not reached after a predetermined time, the RIS may be released. Also, or alternatively, the RIS may be released after the session between the WTRU and BS is stopped. In certain scenarios, a link (e.g., a direct link) between the WTRU and the gNB may not exist. If a link between the gNB and the WTRU does not exist, the RIS may be configured before a connection can be established. One or more of the following may apply.

The RIS configuration may be varied, for example, to synchronize with the transmission of the SS block. When a WTRU receives the SS block, the WTRU may synchronize with the network and receive system information from the PBCH. The PBCH may include information about the timing and/or periodicity of the RIS configuration. After reception of the PBCH, the WTRU may know that the timing associated with the network and the RIS/RIS controller. If a WTRU seeks to establish a connection for data transmission, the WTRU may reserve the RIS and inform the RIS controller that the WTRU is able to receive signals from the gNB with the corresponding RIS configuration. The RIS configuration may (e.g., initially) be set to this configuration. If, for example, the measured SNR is less than the threshold SNR, the set RIS configuration may be used as the starting point for the search process, which may speed up the search (e.g., if the WTRU has not moved far from the position where it was able to receive the SS block). When the target SNR is reached, the RIS configuration process may be stopped, and the WTRU may begin data transmission. If the threshold SNR is not reached after a predetermined time, the RIS may be released.

FIG. 6 illustrates an example associated with the control signaling for a RIS configuration. At step 604, the WTRU may receive and detect one or more SSS and/or PBCH transmissions that are periodically transmitted by the gNB. The SSS and/or PBCH may be reflected by the RIS or received directly by the WTRU from the gNB. At step 606, the WTRU may perform synchronization with the gNB and/or RIS. The WTRU may also discover the RIS. At step 608, the WTRU may establish a connection with the RIS and measure a performance metric (e.g., SNR). If the performance metric is below a threshold, the WTRU may request the RIS service, e.g., by sending a RIS reservation request. At step 610, the WTRU may receive an indication regarding the RIS's availability from the RIS or RIS controller. The indication may comprise a RIS reservation acknowledgment (RACK), a RIS reservation negative acknowledgement (RNACK), or any other indication detailing the availability for the RIS for use by the WTRU. At step 612, the WTRU may then receive CSI configuration information (e.g. Channel State Information Reference Signal (CSI-RS)) from the gNB. The CSI configuration information may be reflected by the RIS before arriving at the WTRU. At step 614, the WTRU may measure the signal quality (e.g., via SNR) and, based on the measurement, may send a request (e.g., RIS configuration update request) to the RIS or RIS controller for an updated RIS configuration in an attempt to increase the SNR. For example, the WTRU may send the request (e.g., RIS configuration update request) to the RIS or RIS controller for an updated RIS configuration if the measurement (e.g., SNR) is below a threshold.

At step 616, the signal quality measurement (e.g., SNR) threshold is reached and/or the time limit is reached. At step 618, the RIS configuration process may be terminated by the WTRU, gNB, RIS, and/or RIS controller. If the threshold is not reached and the time limit is exceeded, the RIS may be released by the WTRU, gNB, RIS, and/or RIS controller. If the threshold is reached, data transmission may start. At step 620, the WTRU may receive scheduling information, via the RIS, for transmitting data to the gNB or receiving data from the gNB. The gNB may transmit the scheduling information via a PDSCH or a PDCCH. At step 622, the WTRU may receive data, via the RIS, based on the scheduling information, using a PDSCH. The WTRU may also send data, via the RIS, to the gNB using a PUSCH.

In a several cases, a WTRU may comprise a processor (e.g., the processor 118 illustrated in FIG. 1B) configured to receive RIS discovery information indicating that a RIS is present (e.g., available, within range) for transmissions in a cell. RIS discovery information may comprise one or more positions of the RIS in a cell, RIS capability (e.g., the capabilities of each of RIS in the cell), the number of unit-cells, and/or the like. RIS discovery information may be comprised within synchronization signal (SS) blocks (e.g., with periodicity between 10 ms and 160 ms). The SS block may include a PSS, an SSS, and/or an indication of a PBCH. During an initial access procedure, the WTRU may search for an available cell, and wait to receive the associated SS, PSS, SSS, and/or a PBCH transmission (e.g., the PBCH may comprise RIS discovery information). The WTRU may receive the discovery information in a PBCH.

The WTRU may perform one or more first measurements of one or more first signals to determine a first measurement value. Any measurement/parameter related to channel quality may be used for the RIS control. In some cases, channel quality and/or channel state information (e.g., SNR calculation) may be based on measurements (e.g., reference signal power) or a calculation (e.g., based on the position of the RIS in the cell). In some cases, the one or more first signals may comprise one or more broadcast signals. The one or more first signals may also, or alternatively, comprise training signals, CSI-RS, SRS, SS, PSS, and/or any signals received via the PBCH and/or the SS. The one or more first measurements may comprise measuring for channel quality and/or channel state information. The one or more first measurements may comprise one or more quality metric measurements (e.g., SNR, RSRP, signal power, noise level, interference level, signal to interference & noise ratio (SINR), block error rate (BLER), peak signal-to-noise ratio (PSNR), geometric signal-to-noise ratio (GSNR), CQI, ACK, and/or NACK). The WTRU may be configured to achieve (e.g., attain, maintain, etc.) a predetermined signal and/or channel quality level, which may be measured using quality metric measurements, such as SNR. The one or more first measurements may also comprise the WTRU performing channel estimation, spectral and/or energy efficiency optimization techniques.

The measurement value may comprise one or more measurements from any of the disclosed measurement techniques disclosed herein. One or more of the following may apply. The WTRU may select the measurement value as being derived from various measurement value types, comprising, the first measurement, the second measurement, the third measurement, the middle measurement, the last measurement, the highest measurement, the lowest measurement, the mean measurement, the median measurement, the mode measurement, logarithmic mean, geometric mean, the measurement occurring during a designated period of time, and/or the nth measurement (e.g. an unspecified measurement number in the series of measurements).

The WTRU may determine that the first measurement value is less than a threshold. The threshold may be defined based on a target set by a used application or service (e.g., the threshold defined from the upper layers, middle layers, lower layers, RRC, PDCP, RLC, MAC, and/or PHY layer), on previous measurement values measured by the WTRU, on a link quality target (e.g., data rate), the WTRU (e.g., operational targets), and/or by any element in the network. In certain cases, the threshold values may be stored in the WTRU (e.g., in a table, database, memory, random-access memory (RAM), processor, and/or cache). In various cases, the WTRU may interpret “less than” as being “less than or equal to.” The comparison between the threshold value and the first measurement may be executed in various ways, for example, by using a digital comparator, analog comparator, and/or magnitude comparator in the WTRU and/or WTRU. The first measurement value being less than the threshold may signify that the signal quality is not good enough or reliable enough to commence data transmission.

The WTRU may send a reservation request to the RIS based on the first measurement value being less than (or less than or equal to) the threshold. Because the signal quality and/or power from the gNB is not high enough, the WTRU may seek the services of the RIS to reflect further signals to increase the measurement value of the signal. The WTRU may send a reservation request to the RIS in the form of a signal.

The WTRU may perform one or more second measurements of one or more second signals received via the RIS to determine a second measurement value. The WTRU may receive a RACK and/or RNACK from the RIS. A RACK may signify to the WTRU that the RIS is available for use by the WTRU, while a RNACK may signify that the RIS is not available for use by the WTRU. In certain cases, a single RIS may be used by two, three or more WTRUs at the same time. In certain cases, the RIS reservation request signal may not arrive at the RIS with a good enough quality for the RIS to discern that the signal is a RIS reservation request. In such cases, the RIS may send a request to the WTRU to resend the signal. In certain cases, the WTRU may not receive a response from the RIS. In such cases, the WTRU may resend the RIS reservation request or may send a reservation request to another RIS. When the RIS sends a RNACK to the WTRU, the RNACK may include a forwarding recommendation with one or more RISs in a network of RISs that the WTRU can alternatively use. After the WTRU receives the RACK, the WTRU may receive one or more second signals (e.g., CSIs, CSI-RSs, and/or tracking reference signals) sent from the gNB and reflected by the RIS. The one or more second measurements may be executed using any of the measurement techniques possible for the one or more first measurements (e.g., the same as one or more previous measurement techniques). In certain cases, a different measurement technique may be used for the second measurement than the first measurements. The second measurement value may be selected using any of the criteria possible for the first measurement value (e.g., the same as one or more previous measurement values). In certain cases, a different measurement value type may be used for the second measurement value than the first measurement value.

The WTRU may determine that the second measurement value is less than the threshold. Similar comparison techniques described in the comparison between the first measurement value and the threshold may be employed here (e.g., the same as one or more previous comparison techniques). In certain cases, a different comparison technique may be used for this comparison than one or more previous comparisons).

The WTRU may send a RIS configuration update request to the RIS based on the second measurement value being less than the threshold. The RIS configuration update request may comprise a signal that when received by the RIS instructs the RIS to modify, vary, and/or change parameters associated with the RIS. These changes may be employed to increase the measurement value of future signals.

After transmission of the RIS configuration update request, the WTRU may be further configured to perform one or more third measurements of one or more third signals received via the RIS to determine a third measurement value. The one or more third measurements may be executed using any of the measurement techniques possible for the one or more first and second measurements (e.g., the same as one or more previous measurement techniques). In certain cases, a different measurement technique may be used for the third measurement than the first and/or second measurements. The second measurement value may be selected using any of the criteria possible for the first measurement value (e.g., the same as one or more previous measurement values). In certain cases, a different measurement value type may be used for the third measurement value than the first and/or second measurement value.

The WTRU may determine that the third measurement value is greater than (alternatively, greater than or equal to) the threshold. Similar comparison techniques described in the comparison between the first measurement value and the threshold, and the second measurement value and the threshold, may be employed here (e.g., the same as one or more previous comparison techniques). In certain cases, a different comparison technique may be used for this comparison than one or more previous comparisons).

The WTRU may perform data transmission via the RIS after determining that the third measurement value is greater than the threshold. Data may include any analog and/or digital signals. Data may be transmitted by the gNB, via the RIS, to the WTRU and/or by the WTRU, via the RIS, to the gNB. The WTRU may periodically take measurements of the data signal quality. If the quality starts to go down (e.g., because the WTRU has moved position and the signal quality is at or below another threshold), the WTRU may send another RIS configuration update request to have the RIS vary one or more of its parameters. If the signal is still at or below the threshold after a time limit is exceeded, the WTRU may send out a reservation request to another RIS that is available.

The WTRU may be further configured to receive the one or more first signals directly (e.g. with interference, aid, and/or reflection from the RIS) from a base station. The WTRU receiving the one or more first signals directly may comprise the one or more first signals refraining from being reflected by the RIS. “Directly” may comprise cases where the WTRU has not established a connection with the RIS and the RIS inadvertently (e.g. incidentally) reflects the one or more first signals.

In other cases, the RIS discovery information may be received via the RIS. In these cases, the RIS reflects, aids, and/or interferes with the one or more signals carrying the RIS discovery information (e.g., before a connection has been made between the WTRU and the RIS). In some cases, the RIS may reflect the RIS discovery information signal based on its previous configuration information with the WTRU or another WTRU. In some cases, the discovery information may be included in the one or more first signals or may be sent as part of another signal.

The one or more first, second, and third signals may be sent by the gNB and reflected by the RIS to the WTRU. The one or more first, second, and third signals may include any combination of signal types disclosed in this application. “Reflected” may include any reflection that modifies the signal power, quality, direction and/or nature. In some embodiments, the one or more first, second, and/or third signals may be sent by the gNB to the WTRU via a physical downlink shared channel (PDSCH) (e.g., with or without reflection by the WTRU).

The WTRU may be further configured to send the reservation request and the RIS configuration update request as a first type of uplink control information (UCI). The first type of UCI may have unique properties for signals sent from the WTRU and received by the RIS.

The WTRU may be further configured to receive an indication regarding an availability of the RIS as a first type of downlink control information (DCI). The first type of DCI may have unique properties for signals sent from the RIS and received by the WTRU.

The properties of the first type of UCI and DCI (e.g., UCI/DCI transmitted between the WTRU and the RIS) may differ from the properties of the second type of UCI and DCI (e.g., UCI/DCI transmitted between the WTRU and gNB). For example, the properties of the first type of UCI and DCI may comprise one or more of the following: different bit structure formats (e.g., more or less bits), more or less fields within certain formats, different arrangements of fields, different number of bits for given fields, different method of determining the amount of bits in fields, different bit sequences, different codebook types used, different number of CSI ports, different methods for determining values for given fields (e.g., frequency hopping flag, modulation and coding scheme, redundancy version, HARQ process number, 1st downlink assignment index, SRS request, rank indicator, layer indicator, wide-band CQI, subband differential CQI and/or the like), different usages, different usages for the same format, and/or different transport processes. These properties of the first type of UCI and DCI (e.g., UCI/DCI transmitted between the WTRU and the RIS) may enable more efficient communication between the WTRU and RIS.

The WTRU may be further configured to receive a broadcast signal, the one or more first, second, and third signals as a second type of downlink control information (DCI), and scheduling information via a physical downlink control channel (PDCCH) as a second type of downlink control information (DCI). The second type of DCI may have unique properties for signals sent from the gNB and received by the WTRU.

The WTRU may be further configured to send, to a base station, a hybrid automatic repeat request acknowledgment (HARQ-ACK), a hybrid automatic repeat request negative acknowledgment (HARQ-NACK), channel state information (CSI), or a scheduling request (SR) for transmission of data, via a physical uplink control channel (PUCCH) or a physical uplink shared channel (PUSCH), as a second type of uplink control information (UCI). The second type of UCI may have unique properties for signals sent from the WTRU and received by the gNB. A HARQ-ACK may indicate that the WTRU has successfully decoded a received transmission. A HARQ-NACK may indicate that the WTRU has failed to successfully decode a received transmission. The success and/or failure of a transmission may be determined, at least in part, based on error detection using one or more cyclic redundancy checks (CRCs). CSI may include any known channel properties of any communication link disclosed herein (WTRU-gNB, WTRU-RIS, RIS-gNB, etc.). CSI may describe how a signal propagates from the WTRU to the gNB and may represent the combined effect of, for example, scattering, fading, and power decay with distance (e.g., channel estimation). CSI may make it possible to adapt transmissions to current channel conditions, which is useful for achieving reliable communication with high data rates. CSI may comprise the type of fading distribution, the average channel gain, the line-of-sight component, and the spatial correlation. A scheduling request may comprise a request, from the WTRU to the gNB, for uplink shared (UL-SCH) resources for a transmission.

In some cases, at least one of the one or more first, second, or third signals may comprise a synchronization signal block (SSB) or a channel state information reference signal (CSI-RS). The SSB and CSI-RIS may include any of the SSB and CSI-RS properties disclosed herein.

The WTRU may be further configured to receive a RIS reservation acknowledgment (RACK) or a RIS reservation negative acknowledgment (RNACK), as a first type of downlink control information (DCI), in response to the reservation request The RACK and RNACK may serve as an indication regarding the availability of the RIS. A RACK may indicate that the RIS is available for connection with the WTRU and/or that the RIS received successfully decoded the RIS reservation request. A RNACK may indicate that the RIS is not available for connection with the WTRU and/or that the RIS received but failed to successfully decode the RIS reservation request.

In some cases, at least one of the first, second, or third measurement values is a signal-to-noise ratio (SNR). SNR may comprise a ratio of signal power to noise power.

The WTRU may be further configured to release the RIS on a condition that the first, second, and third measurement values are less than (or equal to) the threshold for a period of time. The period of time may comprise a number of slots (e.g., X slots). After the WTRU repeatedly attempts to establish a successful configuration with the RIS for transmission and reception of data with the gNB, the RIS may be released after a given amount of time. “Release” may signify temporarily cutting communication between the WTRU and the RIS, lowering the priority order of the WTRU in a connection/configuration queue at the RIS, setting a time limit before the WTRU may again attempt communication with the RIS, etc.

Configuration of a RIS may be performed during data transmission. For example, in certain scenarios, the link between the WTRU and a network node (e.g., gNB) may be active and the WTRU may move to an area where the measured SNR is less than the SNR threshold. One or more of the following may apply. The drop in the measured SNR may be detected both at the WTRU and gNB (e.g., since the channel is reciprocal). The WTRU and/or the gNB may request the use of the RIS. If use of the RIS is granted for the link, the RIS configuration may be varied, for example, to synchronize with transmitted reference signals. For example, as described herein, configuration of the RIS may be varied (e.g., changed/updated) based on the measurements at the WTRU, and the associated SNR may be measured with the CSI-RS. Also, or alternatively, configuration of the RIS may be performed based on measurements by a network node (e.g., gNB). The measurement results may be reported to gNB using uplink control information (UCI). The gNB may then forward this information to the RIS controller. If the RIS controller is equipped with a transceiver, it may also receive the SNR reporting directly from the WTRU by receiving the UCI. If the RIS configuration is performed based on the SNR at the gNB, the gNB may use the SRS to perform the SNR measurement. In certain scenarios, the SNR may be measured on one (e.g., only one) end of the link. If, for example, the SNR is measured only at one end of the link, the device measuring the SNR (e.g., WTRU or gNB) may not report the measured SNR values to the RIS controller, which may minimize the control signaling between the WTRU and the RIS controller. The device measuring the SNR may inform the RIS controller when the SNR has reached the SNR threshold.

In a TDD link, SNR measurements may be performed at both ends of the link, which may speed up the configuration process.

Although the examples described herein recite SNR as the quality indicator to perform RIS configuration, other quality indicators (e.g., RI, layer indicator (LI), etc.) may also, or alternatively, be used.

The RIS configuration techniques described herein do not limit the control messaging that may occur between the gNB, the WTRU. and/or the controller. For example, one or more of the following may apply. The control plane for RIS configuration may be implemented using a sidelink (e.g., 5G NR sidelink connections). The control plane for RIS configuration may be implemented via an existing network protocol, such as, LTE and/or non-stand-alone 5G. The RIS controller may be a part of an existing system's architecture (e.g., 5G NR infrastructure). The RIS controller may include an Open RAN component. The RIS controller may communicate using non-cellular connections (e.g., Wi-Fi, Bluetooth).

The deployment of RIS units within already existing networks (e.g., 5G NR networks) may create a need to complement the protocol stack of the already existing network.

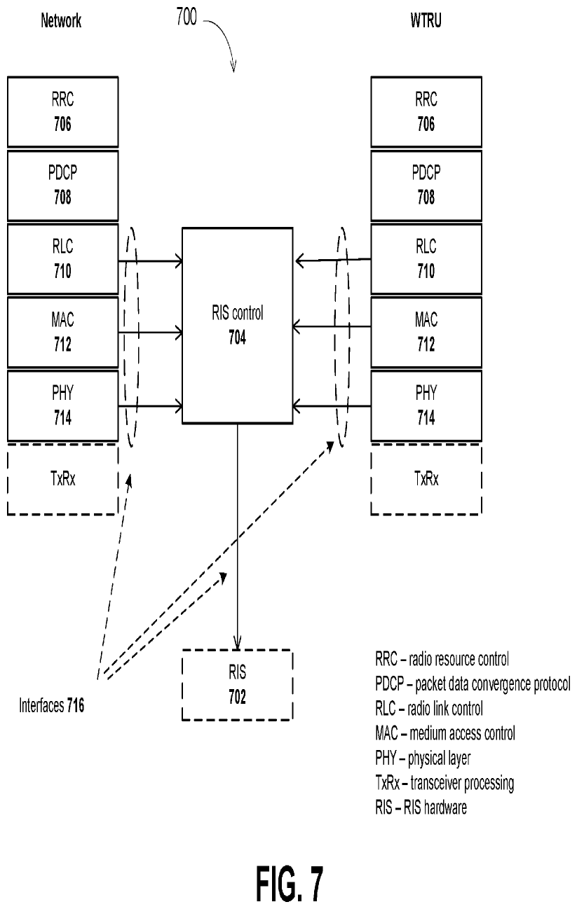

For example, FIG. 7 illustrates an example protocol stack of a system 700 that includes a RIS 702. One or more of the following may apply. The RLC layer 710 may be responsible for the radio resource control in the network. The RLC layer 710 may be updated to incorporate RIS control 704 (e.g., since the RIS 702 may be part of the radio resource). In certain cases, the network may control the RIS with regard to one or more of the following: the transfer of upper layer Protocol Data Units (PDUs); error correction through ARQ; concatenation, segmentation and reassembly of RLC service data units (SDUs); re-segmentation of RLC data PDUs; reordering of RLC data PDUs; duplicate detection; RLC SDU discard; RLC re-establishment; and/or protocol error detection and recovery. For example, the RIS may transfer upper layer Protocol Data Units (PDUs) in one of a plurality of modes, including: an acknowledged mode (AM), an unacknowledged mode (UM), and/or a transparent mode (TM); Changes may be made to the MAC layer 712 (e.g., since the gNB may also serve other nodes that do not employ a RIS). For example, in certain cases, the network may control the RIS with regard to frame delimiting and recognition, control of access to the physical transmission medium, and/or transparent data transfer of low latency communication (LLC) PDUs. SNR measurements for RIS control may be incorporated into the PHY layer 714. For example, in certain cases, the network may control the RIS with regard to communications in the PDSCH, PDCCH, PBCH, PRACH, PUSCH, and/or PUCCH (e.g., as discussed in FIGS. 5 and 6). The RRC protocol 706 in the network layer and the PDCP 708 (located in the Radio Protocol Stack in the UMTS/LTE/5G air interface on top of the RLC layer) may be changed to incorporate RIS control and communication. Additional interfaces 716, such as, the interfaces between the existing network, the RIS controller and WTRU, and/or the RIS controller and the RIS may be defined.

What is claimed:

1. A wireless transmit/receive unit (WTRU), comprising:
a processor configured to:
receive reconfigurable intelligent surface (RIS) discovery information, the RIS discovery information indicating the presence of a RIS;
perform one or more first measurements of one or more first signals to determine a first measurement value;
determine that the first measurement value is less than a threshold;
send a reservation request to the RIS based on the first measurement value being less than the threshold;
perform one or more second measurements of one or more second signals received via the RIS to determine a second measurement value;
determine that the second measurement value is less than the threshold; and
send a RIS configuration update request to the RIS based on the second measurement value being less than the threshold.

2. The WTRU of claim 1, wherein the processor is further configured to:
perform one or more third measurements of one or more third signals received via the RIS to determine a third measurement value;
determine that the third measurement value is greater than the threshold; and
perform data transmission via the RIS after determining that the third measurement value is greater than the threshold.

3. The WTRU of claim 1, wherein the RIS discovery information is received in a physical broadcast channel (PBCH) transmission.

4. The WTRU of claim 1, wherein the one or more first signals are received from a base station.

5. The WTRU of claim 1, wherein the RIS discovery information is received via the RIS.

6. The WTRU of claim 1, wherein the processor is further configured to send the reservation request and the RIS configuration update request as a first type of uplink control information (UCI).

7. The WTRU of claim 1, wherein the processor is further configured to receive an indication of an availability associated with the RIS.

8. The WTRU of claim 1, wherein the processor is further configured to receive a broadcast signal as a second type of downlink control information (DCI).

9. The WTRU of claim 1, wherein the processor is further configured to receive scheduling information, via a physical downlink control channel (PDCCH), as a second type of downlink control information (DCI).

10. A method implemented by a wireless transmit/receive unit (WTRU), the method comprising:
receiving reconfigurable intelligent surface (RIS) discovery information indicating that a RIS is present for transmissions in a cell;
performing one or more first measurements of one or more first signals to determine a first measurement value;
determining that the first measurement value is less than a threshold;
sending a reservation request to the RIS based on the first measurement value being less than the threshold;
performing one or more second measurements of one or more second signals received via the RIS to determine a second measurement value;
determining that the second measurement value is less than the threshold; and
sending a RIS configuration update request to the RIS based on the second measurement value being less than the threshold.

11. The method of claim 10, further comprising:
performing one or more third measurements of one or more third signals received via the RIS to determine a third measurement value;
determining that the third measurement value is greater than the threshold; and
performing data transmission via the RIS after determining that the third measurement value is greater than the threshold.

12. The method of claim 10, wherein the RIS discovery information is received in a physical broadcast channel (PBCH) transmission.

13. The method of claim 10, wherein the one or more first signals are received from a base station.

14. The method of claim 10, wherein the RIS discovery information is received via the RIS.

15. The method of claim 10, further comprising sending the reservation request and the RIS configuration update request as a first type of uplink control information (UCI).
